(19) United States
(12) Patent Application Publication
(10) Pub. No.: US 2016/0159295 A1
(43) Pub. Date: Jun. 9, 2016

(54) HOOD INSULATOR INCLUDING A NON-WOVEN FABRIC AND A FINE RESONANCE LAYER AND A METHOD OF MANUFACTURING THE SAME

(71) Applicants: HYUNDAI MOTOR COMPANY, Seoul (KR); LG Hausys, Ltd., Seoul (KR)

(72) Inventors: Jung Wook LEE, Bucheon-si (KR); Hong Chan JEON, Suwon-si (KR); Seong Je KIM, Yeosu-si (KR); Jeong Uk SEO, Gyeongju-si (KR); Bong Gyu KANG, Seoul (KR); Sam Hun YUN, Anyang-si (KR); Gil Ho KANG, Gunpo-si (KR)

(21) Appl. No.: 14/948,069

(22) Filed: Nov. 20, 2015

(30) Foreign Application Priority Data
Dec. 3, 2014 (KR) 10-2014-0172514

(51) Int. Cl. B60R 13/08; B32B 5/02; B32B 37/14; B32B 5/24

(52) U.S. Cl. CPC B60R 13/0838; B32B 5/245; B32B 5/022; B32B 37/14; B32B 2255/02; B32B 2255/26; B32B 2307/102; B32B 2605/08

(57) ABSTRACT

A hood insulator including a non-woven fabric and a fine resonance layer comprises a porous substrate and a skin material disposed on a surface of the porous substrate, wherein the skin material comprises the non-woven fabric and the fine resonance layer, the fine resonance layer includes a plurality of perforations, and the fine resonance layer is disposed on the non-woven fabric.

### CROSS-REFERENCE TO RELATED APPLICATION

This application claims priority under 35 U.S.C. §119(a) to Korean Patent Application No. 10-2014-0172514 filed on Dec. 3, 2014, the entire content of which is incorporated herein by reference.

### TECHNICAL FIELD

The present disclosure relates to a hood insulator including a non-woven fabric and a fine resonance layer and a method of manufacturing the same. More particularly, it relates to a hood insulator including a non-woven fabric and a fine resonance layer which effectively reduces the noise of an engine compartment by including a fine resonance layer formed with a large number of perforations in a skin material and by generating an acoustic attenuation phenomenon, which is advantageous for both weight minimization and space maximization because there is no need to increase the weight and the thickness to improve the sound absorption performance. The present disclosure also relates to a method for manufacturing the hood insulator including the non-woven fabric and the fine resonance layer which allows the fine resonance layer to have a uniform printing basis weight and thickness by forming it through a printing technique so that the hood insulator including the non-woven fabric and the fine resonance layer can be mass produced and continuously produced.

### BACKGROUND

Recently, noise reduction for vehicles has increased in importance and customer sensitivity to noise has also increased, such that quietness of the vehicle has become an important item in vehicle development to such an extent as to be utilized in brand marketing.

A hood insulator is a NVH (Noise/Vibration/Harshness) component for the engine compartment of an automobile which basically consists of a non-woven fabric skin material and a porous substrate, and is mounted on a bonnet of the engine compartment to serve to absorb the noise generated from the engine.

In general, in order to improve the sound absorption and insulation performance of the hood insulator, the weight and thickness of the porous substrate are increased. However, if the weight of the porous substrate is increased, although the sound absorption performance of the middle-high frequency band of 1 kHz or more is improved, the sound absorption performance of the middle-low frequency band of 1 kHz or less has no significant improvement, and also this causes a deterioration of fuel consumption due to the increased weight. Also, if the thickness of the porous substrate is increased, the sound absorption performance of middle-low frequency band of 1 kHz or less is improved, but this is limited because of the large restrictions on the potential increase in thickness width because of the characteristics of a narrow car space.

In order to solve the above-mentioned problem, prior techniques have suggested a method of improving the sound absorption performance by forming a resonance structure in a plastic sheet, a film, a non-woven fabric or the like through a mechanical drilling process, and then coupling this with a skin material. However, since a separate mechanical drilling process is required to form perforations, time and cost are added, and since the fabrics are combined with each other after forming a perforated structure on another sheet other than the skin material, there is still a limitation because of the increase in weight.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art.

In one aspect, the present disclosure provides a hood insulator which utilizes an acoustic attenuation principle of a resonance structure by forming a fine resonance structure on the surface of the skin material.

In another aspect, the present disclosure provides a method for manufacturing a hood insulator which includes a fine resonance layer by a rotary screen printing technique.

The aspects of the present disclosure are not limited by this disclosure, other aspects of the present disclosure which have not been mentioned can be understood by the following description and can be more clearly understood by the embodiments of the present inventive concept. Further, the aspects of the present inventive concept can be realized by the means illustrated in the appended claims and combinations thereof.

In order to achieve the above-mentioned aspects, the present disclosure includes the following configuration.

According to an embodiment of the present inventive concept, a hood insulator including a non-woven fabric and a fine resonance layer comprises a porous substrate, and a skin material attached to a surface of the porous substrate, wherein the skin material comprises the non-woven fabric and the fine resonance layer, the fine resonance layer includes a plurality of perforations, and the fine resonance layer is disposed on the non-woven fabric.

According to another embodiment of the present inventive concept, the hood insulator may have a thickness of the skin material from 0.1 to 1.0 mm.

According to another embodiment of the present inventive concept, the hood insulator may have an air permeability of the skin material from 20 to 500 l/m2/s at a pressure of 100 Pa.

According to another embodiment of the present inventive concept, the non-woven fabric includes one or more fibers selected from the group consisting of an organic fiber, a natural fiber, and an inorganic fiber.

According to another embodiment of the present inventive concept, the fine resonance layer is formed by a printing technique.

According to another embodiment of the present inventive concept, the printing technique is a rotary screen printing technique.

According to another embodiment of the present inventive concept, the fine resonance layer includes one or more resins selected from the group consisting of acrylic resin, urethane resin, polyester resin, and bismaleimide resin.

According to another embodiment of the present inventive concept, the fine resonance layer has a basis weight of 50 to 200 g/m2.

According to another embodiment of the present inventive concept, the fine resonance layer has a perforation rate of 1 to 50%.

According to another embodiment of the present inventive concept, the perforations have a diameter of 0.5 to 3.5 mm.

According to another embodiment of the present inventive concept, a diameter, an interval, and a pattern of the perforations are determined by the pattern of a rotary screen roll.

According to another embodiment of the present inventive concept, a method of manufacturing a hood insulator including a non-woven fabric and a fine resonance layer, the method comprising steps of printing the fine resonance layer on the non-woven fabric to form a skin material; and attaching the skin material to a porous substrate.

According to another embodiment of the present inventive concept, the printing technique is a rotary screen printing technique.

According to another embodiment of the present inventive concept, the fine resonance layer is disposed on an outer surface of the hood insulator.

According to another embodiment of the present inventive concept, the fine resonance layer is disposed between the non-woven fabric and the porous substrate.

Since the fine resonance layer is included in the skin material, there is an effect that it is possible to effectively reduce the noise of the engine compartment without increasing the weight and thickness of the hood insulator.

There is also an effect that it is possible to selectively improve the noise reduction performance of a particular frequency band, by permitting the print patterns, such as the diameters and the intervals of the perforations of the fine resonance layer, to be adjusted depending on the pattern of the rotary screen roll.

Since the hood insulator including the non-woven fabric and the fine resonance layer according to the present disclosure has an improved noise reduction performance without increases in weight and thickness, there is an effect that it is possible to achieve lower weight of the automobile components and maximization of the space utilization.

Since the fine resonance layer is formed by a printing process technique, there is an effect that a separate mechanical drilling process is not required and the manufacturing time and costs can be saved.

Other aspects and various embodiments of the inventive concept are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present inventive concept will now be described in detail with reference to certain exemplary embodiments thereof illustrated in the accompanying drawings which are given hereinbelow by way of illustration only, and thus are not limitative of the present inventive concept, and wherein:

FIG. 1 is a diagram illustrating a structure of a cross-section of a hood insulator using a non-woven fabric having a resonance structure according to the present inventive concept;

FIG. 2 is a diagram schematically illustrating a method of manufacturing a hood insulator using a non-woven fabric having a resonance structure according to the present inventive concept;

FIG. 3 is an enlarged photograph of a non-woven fabric and a fine resonance layer;

FIG. 4 illustrates a surface pattern of a rotary screen roll;

FIG. 5 is an enlarged photograph of perforations formed by a rotary screen printing;

FIGS. 6A and 6B are diagrams in which a structure of a cross-section of one embodiment and another embodiment of a hood insulator using a non-woven fabric having a resonance structure of the present inventive concept;

FIG. 7 illustrates a hood insulator manufactured by an example;

FIG. 8 is a graph of a sound absorption performance measurement of an Example and Comparative Examples 1 and 2; and

FIG. 9 is a photograph in which a hood insulator of FIG. 7 is mounted on a real vehicle.

FIG. 10 is a result of measurement of the respective average sound absorption coefficient when placing a space behind the air layer as 10, 30 and 50 mm in the skin material by an impedance tube experimental method.

It should be understood that the appended drawings are not necessarily to scale, presenting a somewhat simplified representation of various features illustrative of the basic principles of the inventive concept. The specific design features of the present inventive concept as disclosed herein, including, for example, specific dimensions, orientations, locations, and shapes will be determined in part by the particular intended application and use environment.

In the figures, reference numbers refer to the same or equivalent parts of the present inventive concept throughout the several figures of the drawing.

### DETAILED DESCRIPTION

Hereinafter reference will now be made in detail to various embodiments of the present inventive concept, Examples of which are illustrated in the accompanying drawings and described below. While the inventive concept will be described in conjunction with exemplary embodiments, it will be understood that present description is not intended to limit the inventive concept to those exemplary embodiments. On the contrary, the inventive concept is intended to cover not only the exemplary embodiments, but also various alternatives, modifications, equivalents and other embodiments, which may be included within the spirit and scope of the inventive concept as defined by the appended claims.

Hereinafter, various embodiments of the present inventive concept will be described in detail with reference to the accompanying drawings so as to be able to be readily implemented by a person having skilled in the art to which the present inventive concept belongs.

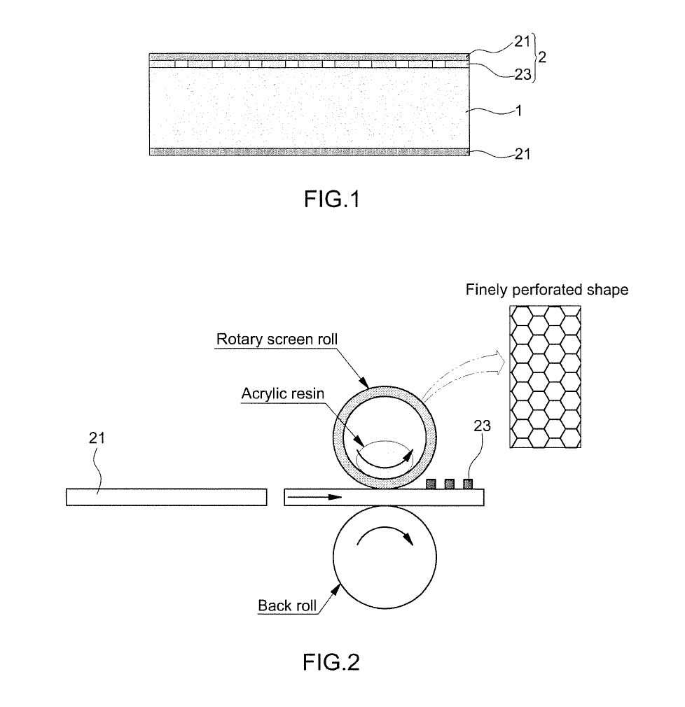

Referring to FIG. 1, a hood insulator using a non-woven fabric having a resonance structure according to the present inventive concept includes a porous substrate 1, and a skin material attached to a surface of the porous substrate 2.

The porous substrate 1 absorbs the noise of the high frequency band depending on the porous structure of the substrate itself and may use a glass wool, a urethane foam, a resin felt or the like.

The skin material 2 has a configuration attached to one side or both sides of the porous substrate 1 and protects the porous substrate from the external environment. In the present inventive concept, a fine resonance structure is formed on the surface of the skin material 2 so that acoustic attenuation due to the resonance effect occurs when the sound wave is incident to the hood insulator, thereby reducing the noise of the engine compartment.

The skin material 2 may have a thickness of 0.1 to 1.0 mm. The reason is that, if the thickness is less than 0.1 mm, there is a risk of tear of the skin material at a bending site when molding the hood insulator, and if the thickness exceeds 1.0 mm, there is a risk of causing a non-flat surface of the skin material after pressing due to insufficient elongation.

The skin material 2 may have air permeability of 20 to 500 l/m²/s at a pressure of 100 pa. The reason is that if the air permeability is less than 20 l/m²/s, the sound wave is not smoothly transmitted to the skin material, and if the air permeability exceeds 500 l/m²/s, the retention time of the sound wave within the porous substance decreases, and the sound absorption performance is lowered. In the present disclosure, the air permeability refers to the volume of air transmitted per unit area (m²) per second.

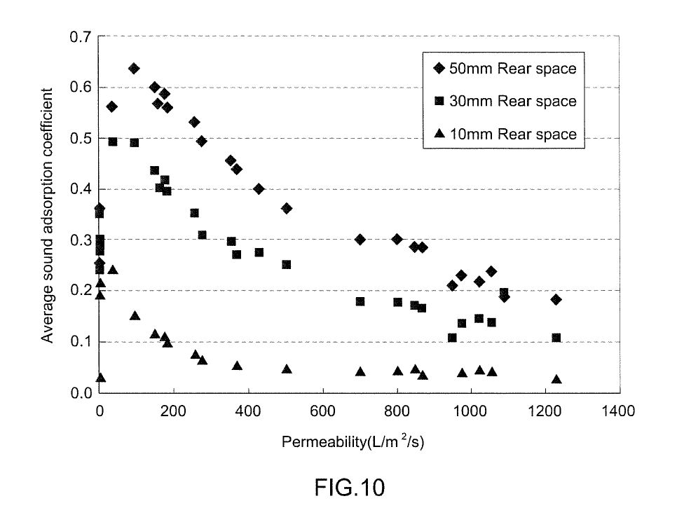

FIG. 10 is a result of measurement of the respective average sound absorption coefficient when placing a space behind the air layer as 10, 30 and 50 mm in the skin material by an impedance tube experimental method. Referring to this, it is possible to confirm that when the skin material in all embodiments has the air permeability of 20 to 500 l/m²/s, the average sound absorption coefficient is greater.

Referring to FIG. 1, the skin material 2 includes a non-woven fabric 21 and a fine resonance layer 23 formed by the printing process technique.

A chemical bonded non-woven fabric may be used as the non-woven fabric 21, and the fiber configuration of the chemical bonded non-woven fabric is not particularly limited, but it may consist of organic fibers such as polyethylene terephthalate (PET), polyethylene (PE) and polypropylene (PP), natural fibers such as pulp, kenaf and jute, inorganic fibers such as glass and silica alone or a mixture thereof, and it is possible to manufacture the chemical bonded non-woven fabric by drying the fiber after it is mixed with an acrylic binder.

The fine resonance layer 23 is formed on the surface of the non-woven fabric 21 by a printing process technique, and has a configuration including a plurality of perforations 231 which will be described later.

Referring to FIG. 2, the fine resonance layer 23 is formed by a rotary screen printing technique, and the detailed contents thereof will be described below.

The fine resonance layer 23 may be made of a material having a heat resistance to such a degree that it is not deformed even if heat is applied at at least 150° C. to 250° C. for 200 hr or more so as not to be degraded at the combining step between the porous substrate 1 and the skin material 2 to be described later. As long as it has the characteristics as described above, any material may also be used, but it is possible to use acrylic resin, urethane resin, polyester resin, bismaleimide resin or the like.

The fine resonance layer 23 may have a print basis weight of 50 to 200 g/m². The reason is that, if the print basis weight is less than 50 g/m², it is difficult to form the fine resonance layer 23 by the printing method, and if the print basis weight exceeds 200 g/m², there is a risk of collapse of the shape of the perforation, and it is also difficult to lighten the hood insulator because it increases the weight. In the present disclosure, the basis weight refers to a mass (g) of the material per unit area (m²).

The fine resonance layer 23 may have a perforation rate of less than 50%. The reason is that, if the perforation rate is 50% or more, a perforated area becomes excessive and it is not possible to obtain the effect of improving the sound absorption coefficient. In the present disclosure, the perforation rate refers to a ratio of the area of perforation to the entire area of the fine resonance layer.

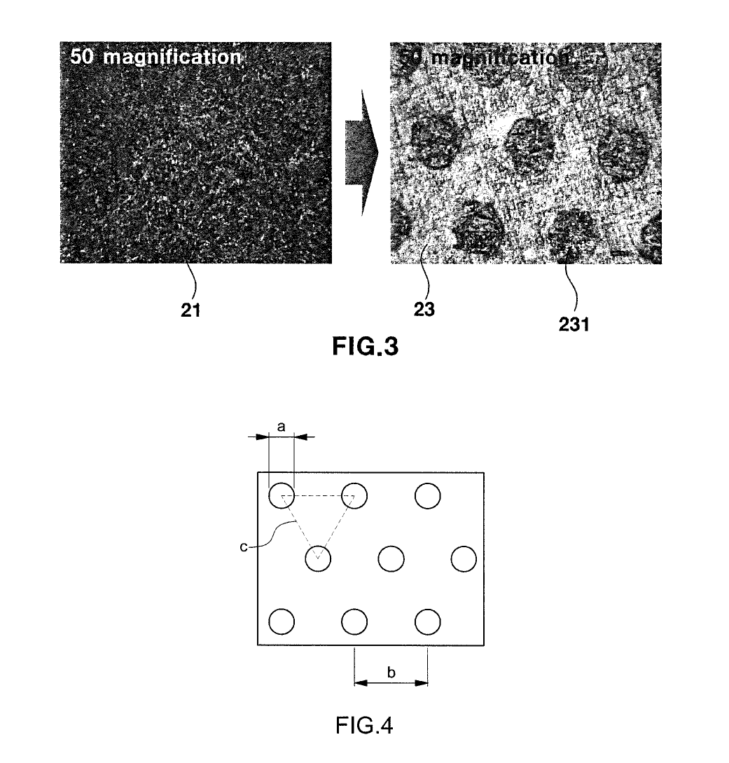

Referring to FIGS. 2 and 3, the perforations 231 are shaped to penetrate through the fine resonance layer 23. Since the resonance occurs when the noise of the engine compartment is incident to the perforations, it is possible to effectively reduce the noise.

The perforations 231 may have a diameter of 0.5 to 3.5 mm. If the diameter is less than 0.5 mm, it is not possible to uniformly implement the shape of the perforations 231 in the printing manner, and even in an extreme case, the perforations 231 may not be formed due to the impregnation of the acrylic resin. If the diameter exceeds 3.5 mm, the area of the perforations 231 is excessive in comparison with the middle-high frequency wavelength band, and the improvement effect of the sound absorption coefficient due to the perforations 231 may be lowered.

As will be described later, the diameters a, the intervals b and the patterns c of the perforations 231 can be determined by the pattern of the rotary screen roll. Accordingly, since the absorption coefficient and sound absorption characteristics for each frequency band change, in the present inventive concept, it is possible to effectively reduce the noise by designing the perforations so that the resonance phenomenon may occur when the noise of a specific frequency band to be reduced is incident to the perforations.

A method of manufacturing the hood insulator using the non-woven fabric having the resonance structure according to the present inventive concept includes a first step of manufacturing a skin material by forming a fine resonance layer on the non-woven fabric by a rotary screen printing technique, a second step of drying the fine resonance layer to gel, and a third step of combining the skin material with the porous substrate by applying heat.

At the first step, the fine resonance layer 23 may be formed using a rotary screen printing technique illustrated in FIG. 2. More particularly, this may involve injecting an acrylic resin into the rotary screen roll, and printing an acrylic resin onto the upper side of the non-woven fabric when the non-woven fabric 21 passes between the rotary screen roll and the back roll.

The fine resonance layer 23 may have a uniform printing basis weight and thickness on the non-woven fabric by being formed by the rotary screen printing technique, and it may be continuously produced and mass-produced.

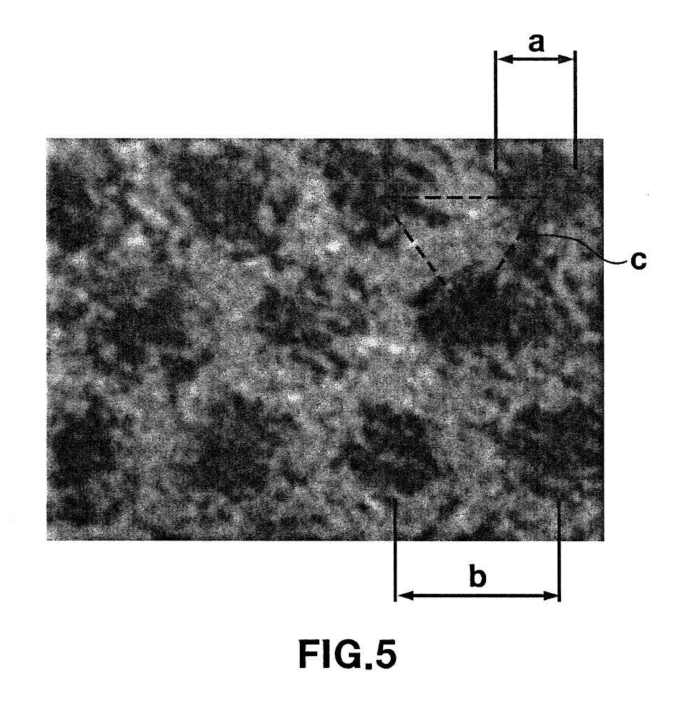

Referring to FIG. 4, the rotary screen roll includes the fine patterns a, b and c on its surface, and referring to FIG. 5, the acrylic resin is printed on the upper side of the non-woven fabric to form a fine resonance layer depending on the pattern. Therefore, the diameter a, the interval b, and the pattern c of the perforation are formed in the same manner as those of the fine pattern of the rotary screen roll. Therefore, it is possible to effectively reduce the noise of a particular frequency band by permitting the perforations to be freely designed.

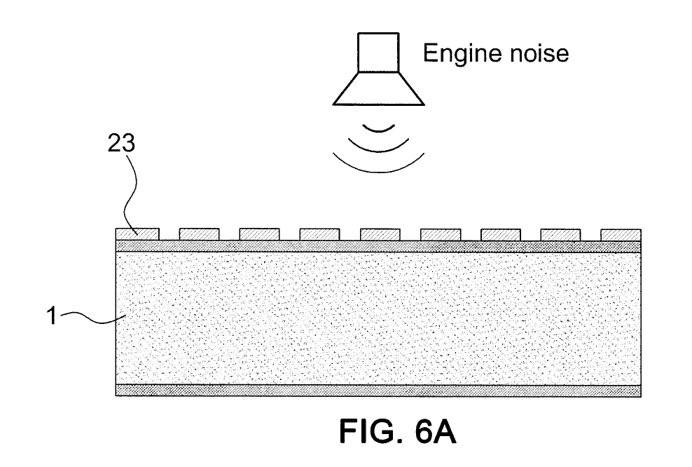

Referring to FIGS. 6A and 6B, when combining the skin material to the porous substrate 1 in the third step described above, the fine resonance layer 23 may be exposed to the outside (FIG. 6A) and may be not be exposed (FIG. 6B). What kind of structure is formed can be determined depending on the manufacturing environment, the purpose of use and the like.

Hereinafter, a specific example of the present inventive concept will be described. Examples described below are intended to specifically illustrate or describe the present inventive concept, but the inventive concept is not limited thereby.

### EXAMPLE

(1) A fine resonance layer including fine and regular perforations was formed on the surface of the non-woven fabric having a thickness of 0.32 mm and a basis weight of 100 g/m² by a rotary screen printing technique. As the acrylic resin which forms the fine resonance layer, one having a heat resistance even at 180° C. was used. As illustrated in FIG. 4, the diameter of the perforations is 1.5 mm, and the interval of the perforations is 2.8 mm. The acrylic resin has a pattern in which the centers of the perforations are repeatedly formed in an equilateral triangular shape. The thickness of the fine resonance layer is 0.28 mm, and the total thickness of the skin material is 0.6 mm.

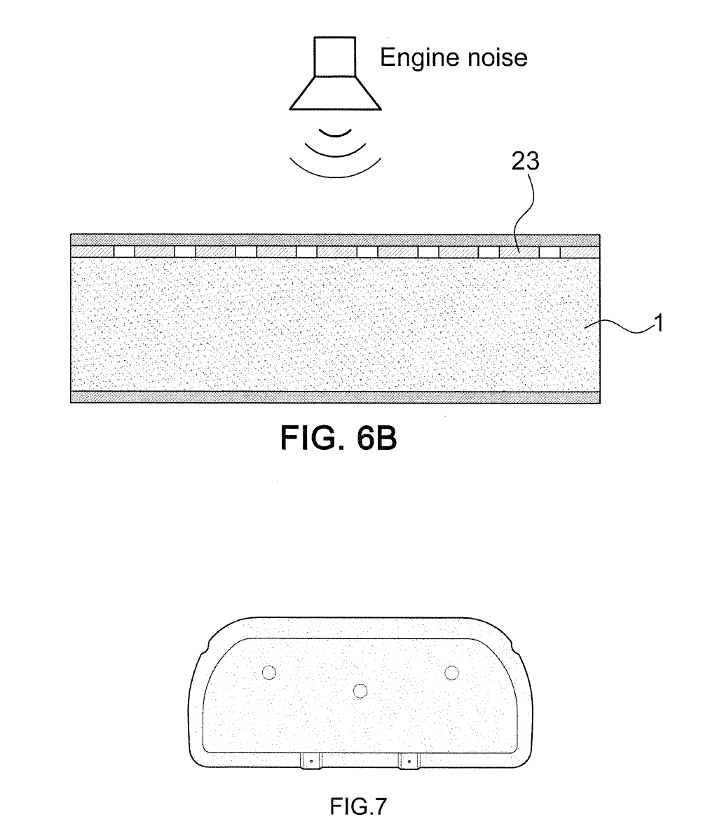

(2) The skin material was combined to the surface of glass wool having a thickness of 35 mm and a basis weight of 700 g/m² by applying heat, and after combining the non-woven fabric having a thickness 0.32 mm and a basis weight of 100 g/m² on the opposite surface of the glass wool, it was molded for 20 seconds at 180° C. to manufacture a hood insulator as in FIG. 7.

### Comparative Example 1

After combining the non-woven fabric having a thickness of 0.32 mm and a basis weight of 100 g/m² on both surfaces of the glass wool having a thickness of 35 mm and a basis weight of 700 g/m², it was molded in a molding die for 20 seconds at 180° C. to manufacture a hood insulator.

### Comparative Example 2

After combining the non-woven fabric having a thickness of 0.32 mm and a basis weight of 100 g/m² on both surfaces of the glass wool having a thickness of 35 mm and a basis weight of 1200 g/m², it was molded in a molding die for 20 seconds at 180° C. to manufacture a hood insulator.

### Measurement Example 1

In order to measure the sound absorption performance of the Example and Comparative Examples 1 and 2, the sound absorption coefficient was measured under conditions of ISO354 using a small reverberation room sound absorption coefficient measuring instrument.

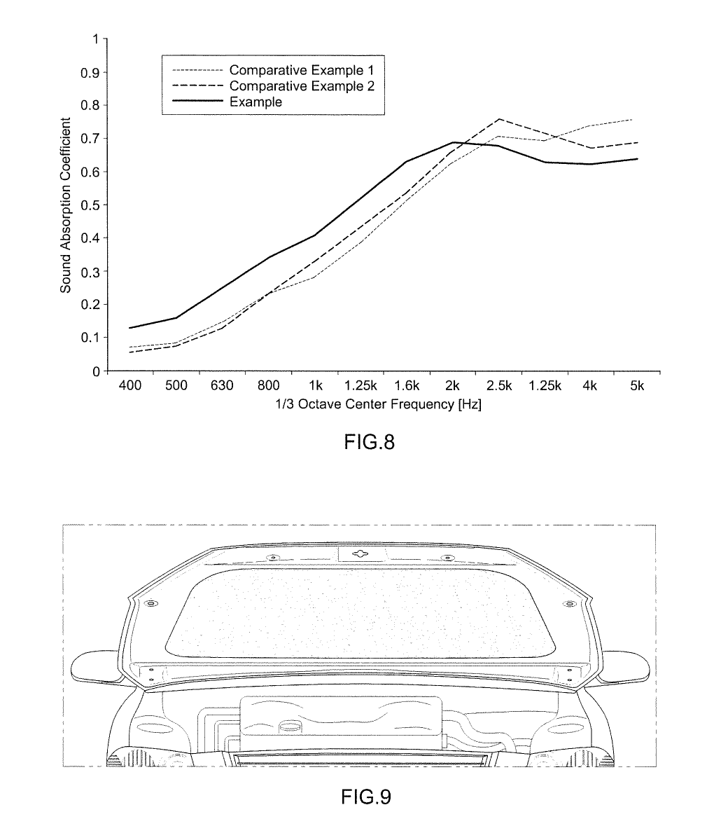

Referring to FIG. 8, it is possible to know that, in the case of the Example, the sound absorption performance is excellent at a level less than 2500 kHz as a middle-low frequency band as compared to Comparative Examples 1 and 2. Especially, in Comparative Example 2, even though the basis weight (weight) of the porous substrate increased in amount of 500 g/m² as compared to the Example, it was possible to confirm that an absorption coefficient is lower than the Example. This means that, when using the hood insulator using non-woven fabric having the resonance structure according to the present inventive concept, it is possible to improve the noise reduction performance, even if the weight or thickness is not increased.

### Measurement Example 2

As illustrated in FIG. 9, the noise reduction effect when mounting the Example and Comparative Examples 1 and 2 on the actual vehicle was measured. The hood insulator of the Example and Comparative Examples 1 and 2 was mounted on the engine compartment of the vehicle mounted on the semi-anechoic chamber to measure the internal noise of the engine under the Idle condition and Wide Open Throttle (WOT)). The Idle condition means the measurement in about 5 minutes after starting the engine, and the WOT condition means the measurement from 3000 to 5000 RPM in 50 RPM intervals at the second stage of the gear. Hereinafter, Table 1 is a result obtained by deriving a Partial Overall SPL (Sound Pressure Level) within the frequency range from 100 kHz to 3150 kHz during noise measurement.

TABLE 1

| | Idle condition | WOT condition |
|---|---|---|
| Example | 69.81 | 99.83 |
| Comparative Example 1 | 70.10 | 100.17 |
| Comparative Example 2 | 70.36 | 100.22 |

Referring to Table 1, when mounting the hood insulator on the actual vehicle, it was possible to confirm that the noise of Example decreases by 0.3 to 0.5 dB as compared to Comparative Examples 1 and 2. In other words, it means that Example have the noise reduction effect of 30% to 40% as compared to Comparative Examples 1 and 2.

In the hood insulator using the non-woven fabric having the resonance structure according to the present inventive concept, since the skin material includes a fine resonance layer including a plurality of perforations, there is an advantage that it is possible to effectively reduce the noise generated from the engine compartment using the acoustic attenuation principle of the resonance structure.

Also, in the hood insulator using the non-woven fabric having the resonance structure according to the present inventive concept, by forming a fine resonance layer on the skin material itself without attaching a separate porous sheet to the skin material, there is an advantage of effectively reducing the noise even without increasing the weight and thickness of the hood insulator.

Further, according to a method of manufacturing the hood insulator using the non-woven fabric having the resonance structure of the present inventive concept, by forming a fine resonance layer on the upper side of the non-woven fabric by a rotary screen printing technique, there is an advantage in that the fine resonance layer has a uniform printing basis weight and thickness and can be continuously produced and mass-produced.

Further, according to the method of manufacturing the hood insulator using the non-woven fabric having the resonance structure of the present inventive concept, by designing the perforations of the fine resonance layer using the pattern of the rotary screen roll, there is an advantage of being able to selectively improve the noise reduction performance of a particular frequency band.

Although the Example of the present inventive concept has been described above in detail, the scope of the present inventive concept is not limited to the above-described Example, and various modifications and improved forms of those skilled in the art that utilize the basic concept of the present inventive concept that is defined in the following claims are also included in the scope of the present inventive concept.

The inventive concept has been described in detail with reference to various embodiments thereof. However, it will be appreciated by those skilled in the art that changes may be made in these embodiments without departing from the principles and spirit of the inventive concept, the scope of which is defined in the appended claims and their equivalents.

What is claimed is:

1. A hood insulator including a non-woven fabric and a fine resonance layer comprising:
a porous substrate,
and a skin material attached to a surface of the porous substrate,
wherein the skin material comprises the non-woven fabric and the fine resonance layer, the fine resonance layer includes a plurality of perforations, and the fine resonance layer is disposed on the non-woven fabric.

2. The hood insulator of claim 1, wherein a thickness of the skin material is 0.1 to 1.0 mm.

3. The hood insulator of claim 1, wherein an air permeability of the skin material is 20 to 500 l/m²/s at a pressure of 100 Pa.

4. The hood insulator of claim 1, wherein the non-woven fabric includes one or more fibers selected from the group consisting of an organic fiber, a natural fiber, and an inorganic fiber.

5. The hood insulator of claim 1, wherein the fine resonance layer is formed by a printing technique.

6. The hood insulator of claim 5, wherein the printing technique is a rotary screen printing technique.

7. The hood insulator of claim 1, wherein the fine resonance layer includes one or more resins selected from the group consisting of acrylic resin, urethane resin, polyester resin, and bismaleimide resin.

8. The hood insulator of claim 1, wherein the fine resonance layer has a basis weight of 50 to 200 g/m².

9. The hood insulator of claim 1, wherein the fine resonance layer has a perforation rate of 1 to 50%.

10. The hood insulator of claim 1, wherein the perforations have a diameter of 0.5 to 3.5 mm.

11. The hood insulator of claim 1, wherein a diameter, an interval, and a pattern of the perforations are determined by the pattern of a rotary screen roll.

12. A method of manufacturing a hood insulator including a non-woven fabric and a fine resonance layer, the method comprising steps of:
printing the fine resonance layer on the non-woven fabric to form a skin material; and
attaching the skin material to a porous substrate.

13. The method of claim 12, wherein the printing technique is a rotary screen printing technique.

14. The method of claim 12, wherein the fine resonance layer is disposed on an outer surface of the hood insulator.

15. The method of claim 12, wherein the fine resonance layer is disposed between the non-woven fabric and the porous substrate.
